(19) United States
(12) Patent Application Publication
(10) Pub. No.: US 2010/0031450 A1
(43) Pub. Date: Feb. 11, 2010

(54) Liquid Washing Or Cleaning Agent With A Flow Limit

(75) Inventors: Carine Wattebled, Duesseldorf (DE); Soeren Hoelsken, Duesseldorf (DE)

Correspondence Address: Ratner Prestia, P.O. Box 980, Valley Forge, PA, 19482, US

(73) Assignee: Henkel AG & Co. KGaA, Duesseldorf (DE)

(21) Appl. No.: 12/578,743

(22) Filed: Oct. 14, 2009

Related U.S. Application Data
(63) Continuation of application No. PCT/EP2008/052699, filed on Mar. 6, 2008.

(30) Foreign Application Priority Data
Apr. 23, 2007 (DE) 10 2007 019 373.6

(51) Int. Cl. C11D 3/37

(52) U.S. Cl. 8/137; 510/301

(57) ABSTRACT

Liquid, transport- and storage-stable washing or cleaning agents with a flow limit are described which contain a photocatalytic material and a thickening system. The washing or cleaning agents enable textile cleaning, care, finishing, softening and/or conditioning using light with a wavelength in the range from 10-1200 nm. They likewise enable cleaning of hard surfaces using light in the wavelength range from 10-1200 nm.

### CROSS REFERENCE TO RELATED APPLICATIONS

This application is a continuation under 35 U.S.C. §§120 and 365(c) of International Application PCT/EP2008/052699, filed on Mar. 6, 2008. This application also claims priority under 35 U.S.C. §119 of DE 10 2007 016 382.9, filed on Apr. 23, 2007. The disclosures of PCT/EP2008/052699 and DE 10 2007 016 382.9 are incorporated herein by reference in their entirety.

### BACKGROUND OF THE INVENTION

The present invention relates to a liquid washing or cleaning agent with a flow limit containing photocatalytic material and a thickening system. It relates to a method for applying photocatalytic material onto textiles and to a method for textile cleaning, care, finishing, softening and/or conditioning. It furthermore relates to a method for cleaning hard surfaces.

The use of photocatalytic materials for combating dirt and/or unwanted microorganisms is desirable because the photocatalytic material is capable of making use of electromagnetic radiation of a suitable wavelength in order to degrade or deactivate dirt and/or undesired microorganisms by a photocatalytic or photochemical reaction.

A suitable photocatalytic material generally comprises very finely divided substances, for example of the order of magnitude of at least <500 nm. Incorporating such photocatalytic material into liquid washing and cleaning agents may give rise to problems. In particular, the photocatalytic material may settle out or float to the surface of the liquid washing or cleaning agent. The consumer would then have to shake such a liquid washing or cleaning agent before each use in order to homogenize it again, which, although straightforward, is nevertheless inconvenient.

The consumer therefore generally wishes at the time of use to be able to make direct use of such liquid washing and cleaning agents after storage and transport, without having to worry about homogenizing the product by shaking it.

### DESCRIPTION OF THE INVENTION

The object of the present invention was therefore to provide a liquid, storage- and transport-stable washing or cleaning agent which comprises photocatalytic material and which does not have to be shaken by the consumer prior to use.

This object is achieved by a liquid washing or cleaning agent which contains photocatalytic material and a thickening system. Further conventional ingredients of washing and cleaning agents may, of course, also be present.

The washing or cleaning agents according to the invention may be used for cleaning textiles and/or hard surfaces, such as in particular also dishes.

The photocatalytic material contained therein, which is preferably finely divided, in particular comprises particle sizes in the range <500 nm, makes use of electromagnetic radiation of a suitable wavelength range, by means of which for example soiling or microbes may be degraded, deactivated or reduced by photocatalytic or photochemical reaction, for example by oxidation or by reduction. The photocatalytic material is in particular a daylight-active material, in particular a daylight-active bleaching agent, i.e. utilizes the electromagnetic radiation of daylight. Oxygen and/or water must preferably be present to bring about the activity of the photocatalytic material in a preferred manner. The dissolved oxygen present in water or the water (atmospheric humidity) contained in air is sufficient for this purpose.

The photocatalytic activity of the photocatalytic material advantageously relates to natural or artificial light in the wavelength range from 10-1200 nm, preferably from 300-1200 nm, in particular between 380 and 800 nm. If the photocatalytic material in particular makes use of the radiation of the visible range of the spectrum perceivable by the human eye with wavelengths of between 380 and 800 nm for the above-stated purposes of degradation, deactivation or reduction of contamination, a preferred embodiment of the invention is provided. UV light (10-380 nm) is also very advantageous.

Advantageously, even the light reaching enclosed living spaces through glass windows (diffuse daylight) is sufficient to ensure the desired photocatalytic activity of the photocatalytic material. Even light from technical light sources (artificial light), such as for example from conventional commercial incandescent lamps (incandescent bulbs), halogen lamps, fluorescent tubes, compact fluorescent lamps (energy-saving lamps) and from light sources based on light-emitting diodes, is sufficient to bring about the desired action. In particular, natural sunlight gives rise to very good effects.

The photocatalytic material may bring about its action in various ways during and after textile treatment.

The action in the textile treatment bath will firstly be mentioned. If, for example, the textiles to be treated are placed in a tub which contains a washing liquor into which the washing or cleaning agent according to the invention has previously been introduced and this textile treatment bath is then for example exposed to light, for example placed in the sun, the photocatalytic material then brings about a general cleaning action in the textile treatment bath. This is also possible in textile treatment in an automatic washing machine which has a viewing window (porthole), as is usual at least in front loaders and/or in a washing machine with an internal light source.

The action in textile drying will secondly be mentioned. The photocatalytic material deposited during textile treatment onto the textiles to be dried is capable, acting in conjunction with exposure to light, for example by sunlight during open air drying on the washing line, of bringing about a general cleaning action. A similar action can also be achieved in textile drying in an automatic tumble-drier with an internal light source.

The action after textile drying will thirdly be mentioned. Dried textiles are strictly speaking not really dry, but instead have a residual moisture content which is in equilibrium with ambient moisture (room humidity, body moisture). These conditions are sufficient, on exposure to light, for example by sunlight, to bring about a general cleaning action, caused by the photocatalytic material deposited on the textiles. This latter-stated action is particularly advantageous, because the treated items of clothing are, so to speak, provided with long-term protection, such that the clothing is provided with a self-cleaning ability. This self-cleaning ability is for example advantageous to counter the occurrence of fetid odors which rapidly form on clothing for example after strenuous activities which generate sweat (for example sporting activities). This self-cleaning ability is for example advantageous in order to prevent or at least inhibit microbial colonization on textiles. This self-cleaning ability is for example advantageous in order to repel or delay the deposition and strong adhesion of in particular colored soiling on fibers. The photocatalytically active material is advantageous in order to enhance soil release properties for colored soiling. The photocatalytic active material is namely capable, on exposure to light, of destroying the structure of in particular colored soiling (dyes), for example by oxidation. The conjugated double bonds, which are responsible for the absorption of visible light and thus for color in dyes, are cleaved or hydroxylated. The dye loses its color-imparting properties and also its strong fiber adhesion ability. Water solubility is simultaneously increased. In this way, it is possible to prevent a colored stain from, so to speak, “eating into” the textile and so causing permanent damage.

Advantageously, soil release of colored soiling from textiles, which were washed with the washing or cleaning agent according to the invention, is also facilitated. When removing stains from textiles, rapid treatment is usually the top priority because the fresher is a stain, the easier it is to remove. Allowing stains or other soiling, for example blood, coffee, tea, ballpoint pen, fruit, red wine or tar stains, to dry on, in particular for a number of days, should normally be avoided, so that possibly irreversible fiber adhesion does not come about. The present invention provides relief in this case because textiles which were treated with washing or cleaning agents according to the invention demonstrated that the fiber adhesion of stains or other soiling was weakened to such an extent that they could more easily be washed out again.

The washing or cleaning agent according to the invention furthermore allows very gentle textile treatment, for example stain treatment.

Advantageously, not only is the elimination of conventional soiling made possible, but so too is the elimination, deactivation, denaturation or reduction of microbes, in particular of germs, fungi, yeasts, mites, preferably house dust mites, or quite generally of (interior) noxious agents with allergenic potential.

Noxious agents are here taken to mean factors which harm the human body and which are at least capable of impairing human well-being. These are in particular the factors which have just been mentioned, especially microbiological factors such as viruses, bacteria, fungi etc.

As already mentioned, a further advantage of the washing or cleaning agent according to the invention resides in the fact that it contributes to reducing, eliminating or neutralizing fetid odors. The fetid odor may here advantageously be reduced to such an extent that a previously existing odor nuisance is no longer present. The occurrence of fetid odors may be prevented for an extended period. This is also a major advantage, since overall a general cleaning action may be combined in one treatment step with the elimination of harmful microbes and in addition long-term blocking or prevention of fetid odors is achieved. This goes distinctly beyond the function of previous washing or cleaning agents. The occurrence of malodors may thus be reduced.

The general cleaning action which can be observed to be brought about by use of the washing or cleaning agent according to the invention is particularly effective with regard to colored contamination or soiling, which in particular originate from
red to blue anthocyan dyes, such as for example cyanidine, for example from cherries or blueberries,
red bethanidine from beetroot,
orange-red carotenoids, such as for example lycopene, beta-carotene, for example from tomatoes or carrots,
yellow curcuma dyes, such as for example curcumin, for example from curry and mustard,
brown tannins, for example from tea, fruit, red wine,
deep brown humic acid, for example from coffee, tea, cocoa,
green chlorophyll, for example, from green grass,
industrial dyes from cosmetics, inks, colored pens/pencils,
colored metabolites and/or excretory products of molds or other microflora or microbial growth or microbes.

The above-stated advantages also extend to the use of the agents according to the invention for cleaning hard surfaces, such as for example flooring etc.

The washing or cleaning agent according to the invention thus accommodates the washing habits of today's consumers, who increasingly prefer to wash at lower temperatures, for example of <40° C. However, clear die-off of germs only starts at temperatures of >40° C. and it is only above a temperature of 55° C. that most bacteria are killed. Accordingly, if washing is only performed at 30° C. for an extended period, adequate hygienic cleanliness may under certain circumstances no longer be ensured. Use of the washing or cleaning agent according to the invention allows the consumer to wash consistently at T<40° C. while ensuring an improved hygiene action.

The use of the thickening system makes it possible according to the invention to provide storage- and transport-stable washing or cleaning agents with a flow limit.

According to a preferred embodiment of the invention, the thickening system according to the invention contains
a) polyacrylate (derivatives), preferably crosslinked polyacrylates
b) structure-imparting gums, preferably xanthan gum, guar gum, locust bean flour, gellan gum, welan gum or carrageenan,
c) cellulose ether derivatives, such as preferably hydroxyethylcellulose, carboxymethylcellulose, hydroxypropylmethylcellulose, hydroxypropyl-cellulose, ethylhydroxyethylcellulose,
d) clay minerals, preferably phyllosilicates, smectites, montmorillonites and hectorites,
e) mixtures of the above-stated.

The polyacrylate (derivatives) preferably usable according to the invention include polyacrylic and polymethacrylic thickeners, such as for example, the high molecular weight homopolymers, crosslinked with a polyalkenyl polyether, in particular an allyl ether of sucrose, pentaerythritol or propylene, of acrylic acid (INCI name according to the “International Dictionary of Cosmetic Ingredients” of “The Cosmetic, Toiletry, and Fragrance Association (CTFA)”: Carbomer), which are also known as carboxyvinyl polymers. Such polyacrylic acids are obtainable inter alia from 3V Sigma under the trade name Polygel®, e.g. Polygel DA, and from Noveon under the trade name Carbopol®, for example Carbopol 940 (molecular weight approx. 4,000,000), Carbopol 941 (molecular weight approx. 1,250,000) or Carbopol 934 (molecular weight approx. 3,000,000). They furthermore include the following acrylic acid copolymers: (i) copolymers of two or more monomers from the group of acrylic acid, methacrylic acid and the simple esters thereof, preferably formed with C₁₋₄ alkanols (INCI Acrylates Copolymer), which include for instance the copolymers of methacrylic acid, butyl acrylate and methyl methacrylate (CAS name according to Chemical Abstracts Service: 25035-69-2) or of butyl acrylate and methyl methacrylate (CAS 25852-37-3) and which are obtainable for example from Rohm & Haas under the trade names Aculyn® and Acusol® and from Degussa (Goldschmidt) under the trade name Tego® Polymer, for example the anionic non-associative polymers Aculyn 22, Aculyn 28, Aculyn 33 (crosslinked), Acusol 810, Acusol 823 and Acusol 830 (CAS 25852-37-3); (ii) crosslinked high molecular weight acrylic acid copolymers, which include for instance the copolymers, crosslinked with an allyl ether of sucrose or of pentaerythritol, of C₁₀₋₃₀ alkyl acrylates with one or more monomers from the group of acrylic acid, methacrylic acid and the simple esters thereof, preferably formed with C₁₋₄ alkanols (INCI Acrylates/C10-30 Alkyl Acrylate Crosspolymer) and which are obtainable for example from Noveon under the trade name Carbopol®), for example hydrophobized Carbopol ETD 2623 and Carbopol 1382 (INCI Acrylates/C10-30 Alkyl Acrylate Crosspolymer) and Carbopol Aqua 30 (formerly Carbopol EX 473). It is advantageous for the polyacrylate to be a copolymer of an unsaturated mono- or dicarboxylic acid and of one or more C₁-C₃₀ alkyl esters of (meth)acrylic acid.

Gellan gum and xanthan gum may in particular be mentioned from the group of structure-imparting gums. Both are preferably usable according to the invention. Gellan gum is an unbranched anionic microbial heteroexo-polysaccharide with a tetrasaccharide repeating unit, consisting of the monomers glucose, glucuronic acid and rhamnose. Gellan gum forms thermoreversible gels after heating and cooling. The gels are stable over a wide temperature and pH range. Gellan gum may, for example, be purchased from Kelco in various grades under the trade name Kelcogel®.

Xanthan gum is a microbial anionic heteropolysaccharide, which is produced under aerobic conditions by Xanthomonas campestris and some other species and has a molar mass of 2 to 15 million dalton. Xanthan is formed from a chain with β-1,4-linked glucose (cellulose) with side chains. The structure of the subgroups consists of glucose, mannose, glucuronic acid, acetate and pyruvate, the number of pyruvate units determining the viscosity of the xanthan gum.

Xanthan gum may be described by the following formula (1):

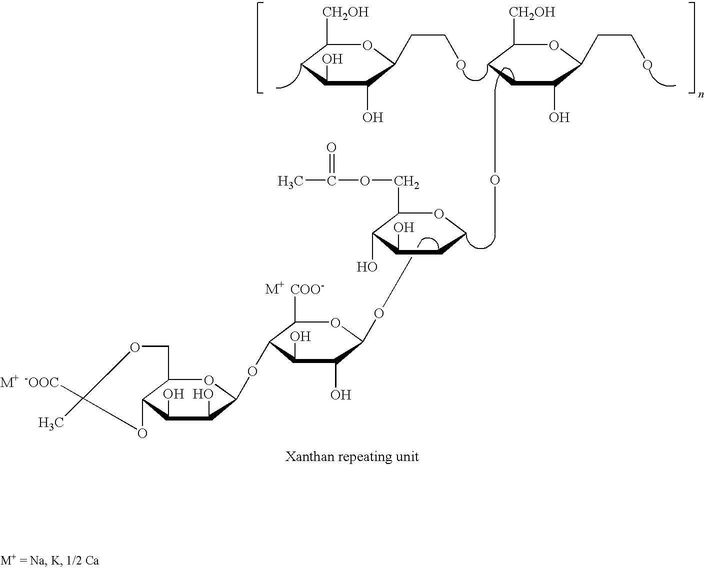

Xanthan gum is obtainable for example from Kelco under the trade names Keltrol® and Keizan® or also from Rhodia under the trade name Rhodopol®.

In particular, such thickener systems which contain a combination of polyacrylate (derivative) and other thickeners, in particular a combination of structure-imparting gums and polyacrylate (derivative) or a combination of cellulose ether derivatives and polyacrylate (derivative), give rise to particularly stable washing or cleaning agents with a flow limit according to the invention. Using such thickener systems is therefore a preferred embodiment of the invention. It should be noted in this that according to the invention the term “thickener system” also includes single component systems, i.e. a thickener system may for example be based solely on a crosslinked polyacrylate. It is, however, advantageous according to the invention to use at least two-component systems, in particular those described above.

If the washing or cleaning agent according to the invention contains a polyacrylate (derivative) in a quantity of 0.1 to 7.0 wt. % and preferably of 0.5 to 5 wt. %, which corresponds to a preferred embodiment of the invention, very good stability values may be achieved for the washing or cleaning agent according to the invention.

According to another preferred embodiment of the invention, the washing or cleaning agent according to the invention contains 0.01 to 4.0 wt. % and preferably 0.1 to 1.5 wt. % of structure-imparting gums, preferably gellan gum and/or xanthan gum. This results, in particular in the case of combined use with polyacrylate(s)/polyacrylate derivative(s) to very good stability values for the washing or cleaning agent according to the invention.

If the washing or cleaning agent according to the invention contains cellulose ether derivatives in quantities of 0.01 to 2.0 wt. % and preferably of 0.05 to 3 wt. %, a preferred embodiment of the invention is in turn provided. Here too, in particular in the case of combined use with polyacrylate(s)/polyacrylate derivative(s), very good stability values for the washing or cleaning agent according to the invention are observed.

In a preferred embodiment, the washing or cleaning agent according to the invention contains microcapsules or speckles, with a diameter along their largest spatial extent of 0.01 to 10,000 μm, as dispersed particles, these microcapsules or speckles preferably containing nanoscale photocatalytic material, preferably the entirety of the photocatalytic material. The washing or cleaning agent according to the invention may not only contain photocatalytic material dispersed as such, but it may also contain photocatalytic material which is present in microcapsules or speckles, and it may likewise contain photocatalytic material dispersed as such and simultaneously also photocatalytic material present in microcapsules or speckles. Microcapsules or speckles may also be present which do not contain any photocatalytic material, but instead other active substances.

Nanoscale photocatalytic material has a particle size (relative to the diameter along the greatest spatial extent) of <500 nm.

The use of microcapsules or speckles allows a particularly homogeneous distribution of the photocatalytic material in the liquid matrix. This also gives rise to still further improved stability of the washing or cleaning agent according to the invention. In particular, possible decomposition processes which could otherwise at least hypothetically arise from the activity of the photocatalytic material in the washing agent matrix, may be suppressed to the greatest possible extent. Independently of the use of microcapsules or speckles, it is also highly advantageous to use opaque containers for packaging the washing or cleaning agents according to the invention because this reliably inhibits the activity of the photocatalytic material in the washing or cleaning agent for the period of storage and transport. The use of opaque containers for packaging the washing or cleaning agents according to the invention corresponds to a preferred embodiment of the invention. Single-use portions, for example pouches, are also preferred.

The use of microcapsules or speckles, optionally in combination with the use of opaque containers for packaging, inter alia ensures that the washing or cleaning agent according to the invention is available to the consumer at the time of use with its complete washing and cleaning power and in a visually attractive form.

The term “microcapsules” is taken to mean aggregates which contain at least one solid or liquid core which is enclosed by at least one continuous shell, in particular a polymer shell. They conventionally comprise finely dispersed liquid or solid phases enclosed with film-forming polymers, during the production of which the polymers, after emulsification and coacervation or interfacial polymerization, are deposited on the material to be enclosed. The microscopically small capsules may be dried as a powder. In addition single-core microcapsules, multi-core aggregates, also known as microspheres, are also known which contain two or more cores distributed in the continuous shell material. Single- or multi-core microcapsules may additionally be enclosed by an additional second, third etc. shell. Single-core microcapsules with a continuous shell are preferred. The shell may consist of natural, semi-synthetic or synthetic materials. Natural shell materials are for example gum arabic, agar-agar, agarose, maltodextrins, alginic acid or the salts thereof, for example sodium or calcium alginate, fats and fatty acids, cetyl alcohol, collagen, chitosan, lecithins, gelatin, albumin, shellac, polysaccharides, such as starch or dextran, sucrose and waxes. Semi-synthetic shell materials are inter alia chemically modified celluloses, in particular cellulose esters and ethers, for example cellulose acetate, ethylcellulose, hydroxypropylcellulose, hydroxy-propylmethylcellulose and carboxymethylcellulose, together with starch derivatives, in particular starch ethers and esters. Synthetic shell materials are for example polymers such as polyacrylates, polyamides, polyvinyl alcohol or polyvinylpyrrolidone.

Sensitive, chemically or physically incompatible and volatile components (=active substances) of the washing and cleaning agent according to the invention, in particular the photocatalytic material, may be enclosed in storage- and transport-stable manner in the interior of the microcapsules. Microcapsules may, for example, also accommodate optical brighteners, surfactants, complexing agents, bleaching agents, bleaching activators, colorants and fragrances, antioxidants, builders, enzymes, enzyme stabilizers, antimicrobial active substances, graying inhibitors, antiredeposition agents, pH adjusting agents, electrolytes, foam inhibitors and UV absorbers. Microcapsules may, for example, also contain cationic surfactants, vitamins, proteins, preservatives, detergency boosters or pearlescent agents. The microcapsule fillings may be solids or liquids in the form of solutions or emulsions or suspensions. Microcapsules which contain the photocatalytic material as a suspension are preferred.

For the purposes of manufacture, the microcapsules may be of any desired shape, but they are preferably approximately spherical. Depending on the components contained in their interior and the application, their diameter along their largest spatial extent may be between 0.01 μm (not visually discernible as a capsule) and 10,000 μm. Visible microcapsules with a diameter in the range from 100 μm to 7,000 μm, in particular of 400 μm to 5,000 μm, are preferred. The microcapsules are obtainable by methods known in the prior art, coacervation and interfacial polymerization being of greatest significance. Microcapsules which may be used are any surfactant-stable microcapsules which are commercially offered for sale, for example the commercial products (the shell material is in each case stated between parentheses) Hallcrest Microcapsules (gelatin, gum arabic), Coletica Thalaspheres (maritime collagen), Lipotec Millicapsules (alginic acid, agar-agar), Induchem Unispheres (lactose, microcrystalline cellulose, hydroxypropylmethylcellulose); Unicerin C30 (lactose, microcrystalline cellulose, hydroxypropylmethylcellulose), Kobo Glycospheres (modified starch, fatty acid esters, phospholipids), Softspheres (modified agar-agar) and Kuhs Probiol Nanospheres (phospholipids).

Alternatively or in addition to the microcapsules, it is also possible to use particles which do not have a core-shell structure, but in which the active substance, in particular the photocatalytic material, is instead distributed in a matrix of a matrix-forming material. Such particles are also known as “speckles”.

One preferred matrix-forming material is alginate. Alginate-based speckles are produced by dropwise addition of an aqueous alginate solution, which also contains the active substance(s) to be enclosed, followed by hardening in a precipitating bath containing Ca²⁺ ions or Al³⁺ ions.

It may be advantageous for the alginate-based speckles then to be washed with water and subsequently in an aqueous solution with a complexing agent in order to wash away any free Ca²⁺ ions or free Al³⁺ ions which might interact undesirably with ingredients of the washing and cleaning agent according to the invention, for example the fatty acid soaps. The alginate-based speckles are then washed once more with water in order to remove excess complexing agent.

Alternatively, other matrix-forming materials may be used instead of alginate. Examples of matrix-forming materials comprise polyethylene glycol, polyvinylpyrrolidone, polymethacrylate, polylysine, poloxamer, polyvinyl alcohol, polyacrylic acid, polyethylene oxide, polyethoxyoxazoline, albumin, gelatin, acacia, chitosan, cellulose, dextran, Ficoll®, starch, hydroxyethylcellulose, hydroxypropylcellulose, hydroxypropylmethylcellulose, hyaluronic acid, carb-oxymethylcellulose, carboxymethylcellulose, deacetylated chitosan, dextran sulfate and derivatives of these materials. Matrix formation proceeds in these materials, for example by gelation, polyanion-polycation interactions or polyelectrolyte-metal ion interactions and is well known in the prior art, as is the production of particles with these matrix-forming materials.

The microcapsules, speckles and/or the photocatalytic material as such may be stably dispersed in the washing and cleaning agents according to the invention. Stable means that the agents are stable at room temperature and at 40° C. for a period of at least 4 weeks and preferably of at least 6 weeks without the agents creaming or sedimenting.

The active substances, in particular the photocatalytic material, are conventionally released from the microcapsules or speckles during use of the agents containing them by destruction of the shell or the matrix due to mechanical, thermal, chemical or enzymatic action. In a preferred embodiment of the invention, the washing or cleaning agents according to the invention contain identical or different microcapsules or speckles in quantities of 0.01 to 30 wt. % or of up to 20 wt. % or of up to 10 wt. %, in particular of 0.2 to 8 wt. % and extremely preferably of 0.5 to 5 wt. %.

According to a preferred embodiment of the invention, titanium dioxide, in particular a modified titanium dioxide, preferably a carbon-modified titanium dioxide, is present as the photocatalytic material.

According to a preferred embodiment of the invention, the photocatalytic material, in particular the (preferably modified) titanium dioxide, is present in the washing or cleaning agents according to the invention in quantities of advantageously 0.0001 to 30 wt. %, preferably of 0.001 to 20 wt. %, advantageously of 0.01 to 15 wt. %, more advantageously of 0.1 to 10 wt. %, still more advantageously of 1 to 5 wt. %, relative to the entire washing or cleaning agent.

According to a preferred embodiment, the (preferably modified) titanium dioxide is a carbon-modified titanium dioxide. Differently modified titanium dioxides may, however, also be used, for example nitrogen-modified titanium dioxide or for example titanium dioxide doped with rhodium and/or platinum ions. It is, however, particularly preferred according to the invention for this to comprise a titanium dioxide modified with non-metals.

According to a preferred embodiment, the carbon content of the advantageously carbon-modified titanium dioxide may be in the range from 0.01 to 10 wt. %, preferably from 0.05 to 5.0 wt. %, advantageously from 0.3 to 1.5 wt. %, in particular from 0.4 to 0.8 wt. %. The TiO₂ content of the carbon-modified titanium dioxide is for example advantageously above 95 wt. %, 96 wt. %, 97 wt. %, 98 wt. % or 99 wt. %, relative to the entire carbon-modified titanium dioxide.

If the carbon is only incorporated in a surface layer of the titanium dioxide particles, a preferred embodiment is provided. The modified titanium dioxide may advantageously additionally contain nitrogen.

If the specific surface area of the titanium dioxide, preferably of the modified titanium dioxide, determined by the BET method (BET advantageously determined to DIN ISO 9277: 2003-05, preferably also simplified to DIN 66132: 1975-07) amounts preferably to 50 to 500 m²/g, advantageously to 100 to 400 m²/g, more advantageously to 200 to 350 m²/g, in particular to 250 to 300 m²/g, a preferred embodiment is likewise provided.

According to a preferred embodiment, the carbon-modified titanium dioxide may for example be obtained by intimately mixing a titanium compound which has a BET specific surface area of preferably at least 50 m²/g with an organic carbon compound and heat treating the mixture at a temperature of up to 350° C.

According to a preferred embodiment, the carbon-containing substance usable for this purpose may be a carbon compound which contains at least one functional group, preferably selected from OH, CHO, COOH, NHx, SHx. In particular, the carbon compound may be a compound from the group of ethylene glycol, glycerol, succinic acid, pentaerythritol, carbohydrates, sugars, starch, alkyl polyglucosides, organoammonium hydroxides or mixtures thereof. It is also possible for carbon black or activated carbon to be used as the carbon-containing substance.

It may also be preferred for the carbon-containing substance, which is advantageously mixed with the titanium compound in order, after heat treatment, to obtain the modified titanium dioxide, to have a decomposition temperature of at most 400° C. preferably of <350° C. and particularly preferably of <300° C.

The titanium compound preferably usable for production of the modified titanium dioxide, which compound, according to the above-stated preferred embodiment, is intimately mixed with an organic carbon compound, may be an amorphous, partially crystalline or crystalline titanium oxide or a hydrous titanium oxide or a titanium hydrate or a titanium oxyhydrate, which in turn corresponds to a preferred embodiment.

According to a preferred embodiment, the heat treatment of the mixture of the titanium compound and the carbon compound may advantageously be carried out in a continuously operated calcination unit, preferably a cylindrical rotary kiln.

In particular in the previously described context, the modified titanium dioxide may preferably be obtained for example by obtaining a titanium dioxide (for example with a particle size in the range between 2 and 500 nm or for example from 3 to 150 nm or for example from 4 to 100 nm or for example from 5 to 75 nm or for example from 10 to 30 nm or for example from 200 to 400 nm), as is for instance conventionally commercially obtainable in powder or slurry form, and producing therefrom a suspension in a liquid, such as preferably water. A carbon-containing substance is advantageously then added and mixing performed. Mixing may be assisted by the use of ultrasound. The mixing operation (for example stirring) may preferably last for a number of hours, preferably 2, 4, 6, 8,10 or 12 hours or even longer.

Relative to the solids content of the suspension, the quantity of the carbon compound advantageously amounts to 1-40 wt. % and the quantity of the titanium compound accordingly preferably amounts to 60-99 wt. %.

The liquid is then removed, for example by filtration, evaporation under a vacuum or decanting, and the residue is preferably dried (for example preferably at temperatures of 70-200° C., advantageously over a number of hours, for example at least 12 hours) and then calcined, for example at a temperature of at least 260° C., preferably for example at 300° C., preferably over a period of a number of hours, preferably 1-4 hours, in particular 3 hours. Calcination may advantageously proceed in a closed vessel.

It may be advantageous for the calcination temperature, for example 300° C., to be reached within one hour (slow heating to 300° C.).

The powder is here preferably observed to undergo a color change from white via dark brown to beige or pale yellow-brownish. Excessively long heating gives rise to inactive, colorless powders. A person skilled in the art can estimate this with a few routine tests. Calcination may, for example, advantageously proceed for a period such that, after a color change of the powder from white via dark brown, a further color change to beige or pale yellow-brownish takes place.

A maximum temperature of 350° C. should preferably not be exceeded here. During the heat treatment, the organic carbon compound decomposes on the surface of the titanium compound, such that a modified titanium dioxide is preferably obtained which preferably contains 0.005-4 wt. % carbon.

After heat treatment, the product is advantageously disagglomerated by known methods, for example in a pin mill, jet mill or opposed jet mill. The grain fineness to be achieved depends on the grain size of the starting titanium compound. The grain fineness or specific surface area of the product is only slightly below, but of the same order of magnitude as, that of the educt. The desired grain fineness of the photocatalyst depends on the field of use of the photocatalyst. It is conventionally in the range as for TiO₂ pigments, but may also be below or above this range.

The photocatalytic material, preferably modified titanium dioxide, present in the washing or cleaning agent according to the invention may advantageously have a particle size in the range between 2 and 500 nm, thus for example 3 to 150 nm or for example 4 to 100 nm or for example 5 to 75 nm or for example 10 to 30 nm or for example 200 to 400 nm. The particle size of the photocatalytic material, preferably modified titanium dioxide, may in particular preferably be in the range from 100-500 nm, advantageously 200-400 nm. It may also be preferred for the particle size to be very small, for example in the range from 2-150 nm, preferably 3-100 nm, advantageously 4-80 nm or for example 5-50 nm or for example 8-30 nm or for example 10-20 nm. Very small particles, for example with a particle size of in particular 2, 3, 4, 5 or 10 nm are preferably present; these may also form agglomerates with one another which are then correspondingly larger, for example up to 600 nm or up to 500 nm or up to 400 nm or up to 300 nm etc. in size.

The particle size may for example advantageously be at values such as 5 nm, 10 nm, 15 nm, 20 nm, 25 nm, 30 nm, 35 nm, 40 nm, 45 nm, 50 nm or 60 nm. Very small particle sizes of below 50 nm, below 40 nm, below 30 nm or below 20 nm may in particular be preferred.

When producing the modified titanium dioxide, it may be advantageous to start from micronized titanium dioxide, thus from titanium dioxide with a very small particle size, for example between 2 and 150 nm or for example between 5 and 100 nm. The particle size may then for example advantageously be at values such as 2 nm, 3 nm, 4 nm, 5 nm, 10 nm, 15 nm, 20 nm, 25 nm, 30 nm, 35 nm, 40 nm, 45 nm, 50 nm or 60 nm. Such values are preferred.

The bulk density of the preferably modified titanium dioxide is preferably in the range from 100 to 800 g/l, advantageously from 200 to 600 g/l, in particular from 300-500 g/l. The bulk density may, for example, amount to 350 g/l, 400 g/l or 500 g/l.

According to a preferred embodiment, the (preferably modified) titanium dioxide is present in the anatase crystal modification.

The above-described modified titanium dioxide is distinguished by very good photocatalytic activity, in particular when daylight is utilized. In particular, the described modified titanium dioxide very effectively utilizes the radiation of the visible range of the spectrum perceivable by the human eye with wavelengths of between 380 and 800 nm for the purposes of degrading, deactivating or reducing contamination. UV radiation between 10 and 380 nm may also be utilized very effectively. However, for the purposes of the invention, it is also possible to make use of any other photocatalytic materials exhibiting photoeffects which may be utilized for cleaning purposes, such as in particular photochemical and/or photocatalytic oxidation or reduction.

According to a preferred embodiment of the invention, the washing or cleaning agent according to the invention contains a humectant, preferably glycerol, dimers and trimers of glycerol, ethylene glycol, propylene glycol, sugar alcohols, such as preferably glucitol, xylitol, mannitol, alkyl polyglucosides, fatty acid glucamides, sucrose esters, sorbitans, polysorbates, polydextrose, polyethylene glycol, preferably with average molecular weights of 200 to 8000, propanediols, butanediols, triethylene glycol, hydrogenated glucose syrup and/or mixtures of the above, preferably in quantities of 0.01 to 10 wt. %, advantageously of 0.1 to 5 wt. %, in particular of 0.5 to 2 wt. %, in each case relative to the entire washing or cleaning agent.

It has been found that the presence in the washing or cleaning agent of at least one, preferably organic, humectant, brought about improved deposition and action of the finely divided photoactive material on the substrates to be treated in the context of a cleaning process, for example in conventional textile cleaning. One particularly suitable humectant is glycerol and its dimers and trimers and/or mixtures thereof. We were able to establish that, in the presence of the preferably organic humectant, very particularly good action of the agent against contamination was achieved, in particular when using glycerol.

According to a preferred embodiment of the invention, the washing or cleaning agent according to the invention contains
a) anionic surfactants, such as for example alkylbenzene sulfonate, alkyl sulfate, in quantities of advantageously 0-40 wt. %, preferably of 5-30 wt. %, in particular of 15-25 wt. %,
b) nonionic surfactants, such as for example fatty alcohol polyglycol ethers, alkyl polyglucoside, fatty acid glucamide, advantageously in quantities of 0-25 wt. %, preferably of 1-20 wt. %, in particular of 10-15 wt. %,
c) builders, such as for example polycarboxylate, sodium citrate, advantageously in quantities of 0-15 wt. %, preferably of 0.01-10 wt. %, in particular of 0.1-5 wt. %,
d) foam inhibitors, such as for example soap, silicone oils, paraffins, advantageously in quantities of 0-4 wt. %, preferably of 0.2-2 wt. %, in particular of 1-3 wt. %,
e) enzymes, for example proteases, amylases, cellulases, lipases, mannanases, tannases advantageously in quantities of 0-2 wt. %, preferably of 0.2-1 wt. %, in particular of 0.3-0.8 wt. %,
f) optical brighteners, for example stilbene derivative, biphenyl derivative, advantageously in quantities of 0-0.3 wt. %, in particular of 0.1-0.4 wt. %,
g) optional fragrances,
h) optional stabilizers,
i) water, preferably in quantities of 0-80 wt. %,
j) soap, advantageously in quantities of 0-20 wt. %, preferably of 2-15 wt. %, in particular of 5-10 wt. %,
k) alcohols/solvents, advantageously in quantities of 0-25 wt. %, preferably of 1-20 wt. %, in particular of 2-15 wt. %,
l) photocatalytic material
m) thickening system,
o) optional humectants,
p) optional skin-conditioning active substances, preferably in a quantity of 0 to 15 wt. %, advantageously of 0.1-10 wt. %, in particular of 0.5 to 5 wt. %,
q) optional pH adjusting agents, preferably selected from the group of acids, such as in particular acetic acid, citric acid, maleic acid, formic acid, amidosulfonic acid, phosphoric acid, phosphonic acids, D-lactic acid, L-lactic acid, D/L-lactic acid, oxalic acid or from the group of alkalis, such as in particular sodium hydroxide solution, advantageously in quantities of 0-30 wt. %, preferably of 0.01-5 wt. %, in particular of 0.1-3 wt. %, in each case relative to the entire agent.

It has furthermore been found that the combination of the thickening system to be used according to the invention with optionally usable dipropylene glycol gives rise washing or cleaning agents with a flow limit according to the invention which are particularly stable in storage.

A mixture of dipropylene glycol and 1,2-propanediol may here in particularly preferably be used. This combination may contribute to achieving higher flow limits. The ratio of dipropylene glycol to 1,2-propanediol may preferably amount to 3:1 to 1:3, in particular it is 1:1.

The quantity of optionally usable solvent (with the exception of water) preferably amounts to 0.5 to 25 wt. % and in particular to 2 to 15 wt. %, relative to the entire agent.

If the washing or cleaning agent according to the invention is aqueous, thus contains at least >5 wt. %, preferably >10 wt. %, in particular >15 wt. % water, a preferred embodiment of the invention is provided. Such washing or cleaning agents may additionally be manufactured straightforwardly and at low cost in existing installations. Greater water contents are also possible, for example >20 wt. %, >25 wt. %, >30 wt. %, >35 wt. %, >40 wt. %, >45 wt. % or also >50 wt. %.

In one particularly preferred embodiment, the washing or cleaning agent according to the invention contains between 2 and 20 wt. %, preferably between 3 and 10 wt. % and very particularly preferably between 4 and 8 wt. % of fatty acid soap.

Fatty acid soaps are an important component for the washing power of an in particular aqueous washing or cleaning agent according to the invention.

It has surprisingly been found that even when a large quantity of fatty acid soap is used, thanks to the use of a thickening system according to the invention, highly stable liquid washing or cleaning agents with a flow limit may still be obtained. The use of elevated quantities (≧2 wt. %) of fatty acid soap in such systems in fact usually gives rise to unstable products.

According to a preferred embodiment of the invention, the washing or cleaning agents according to the invention also contain skin conditioners or skin-conditioning active substances in particular in quantities of >0.01 wt. %, relative to the entire washing or cleaning agent.

Skin conditioners (skin-conditioning active substances) may in particular be such agents which impart an organoleptic advantage to the skin, for example by providing lipids and/or humectant factors. Skin conditioners may be for example proteins, amino acids, lecithins, lipoids, phosphatides, plant extracts, vitamins; while fatty alcohols, fatty acids, fatty acid esters, waxes, vaseline, paraffins may also act as skin conditioners.

Skin-conditioning active substances are any such active substances which impart an organoleptic and/or cosmetic advantage to the skin. Skin-conditioning active substances are preferably selected from the following substances:
a) waxes such as for example carnauba, spermaceti, beeswax, lanolin and/or derivatives thereof and others.
b) hydrophobic plant extracts
c) hydrocarbons such as for example squalenes and/or squalanes
d) higher fatty acids, preferably those having at least 12 carbon atoms, for example lauric acid, stearic acid, behenic acid, myristic acid, palmitic acid, oleic acid, linoleic acid, linolenic acid, isostearic acid and/or polyunsaturated fatty acids and others.
e) higher fatty alcohols, preferably those having at least 12 carbon atoms, for example lauryl alcohol, cetyl alcohol, stearyl alcohol, oleyl alcohol, behenyl alcohol, cholesterol and/or 2-hexadecanol and others.
f) esters, preferably those such as cetyl octanoate, lauryl lactate, myristyl lactate, cetyl lactate, isopropyl myristate, myristyl myristate, isopropyl palmitate, isopropyl adipate, butyl stearate, decyl oleate, cholesterol isostearate, glycerol monostearate, glycerol distearate, glycerol tristearate, alkyl lactates, alkyl citrates and/or alkyl tartrates and others.
g) lipids such as for example cholesterol, ceramides and/or sucrose esters and others
h) vitamins such as for example vitamins A and E, vitamin alkyl esters, including vitamin C alkyl esters and others.
i) sunscreen preparations
j) phospholipids
k) derivatives of alpha-hydroxy acids
m) germicides for cosmetic use, both synthetic, such as for example salicylic acid and/or others, and natural, such as for example neem oil and/or others
n) silicones
   and mixtures of any of the above-stated components.

Preferably usable skin-conditioning active substances are preferably also skin-protecting oils, in particular selected from the group algae oil Phaeophyceae oil, Aloe vera oil Aloe vera brasiliana, apricot kernel oil Prunus armeniaca, arnica oil Arnica montana, avocado oil Persea americana, borage oil Borago officinalis, calendula oil Calendula officinalis, camellia oil Camellia oleifera, thistle oil Carthamus tinctorius, peanut oil Arachis hypogaea, hemp oil Cannabis sativa, hazelnut oil Corylus avellana, St. John's wort oil Hypericum perforatum, jojoba oil Simondsia chinensis, carrot oil Daucus carota, coconut oil Cocos nucifera, pumpkin seed oil Curcubita pepo, candlenut oil Aleurites moluccana, macadamia nut oil Macadamia ternifolia, almond oil Prunus dulcis, olive oil Olea europaea, peach stone oil Prunus persica, rapeseed oil Brassica oleifera, castor oil Ricinus communis, black cumin oil Nigella sativa, sesame oil Sesamium indicum, sunflower oil Helianthus annus, grapeseed oil Vitis vinifera, walnut oil Juglans regia, wheat germ oil Triticum sativum. Use of skin-protecting oils corresponds to a preferred embodiment of the invention.

The optionally present skin-conditioning active substances may be transferred onto the textile during a textile treatment with an agent according to the invention and then in turn be transferred from the textile to the skin when the textile comes into contact with the skin, for example when wearing clothing. In this way, skin-conditioning active substances in the washing or cleaning agents according to the invention are of benefit to the consumer's skin. When using washing or cleaning agents according to the invention which optionally contain skin-conditioning active substances in a manual textile treatment method, the skin-conditioning active substances are of immediate benefit to the consumer's skin, namely when the hand comes into contact with the washing liquor. However, using skin-conditioning active substances is entirely optional.

The present invention also provides a method for producing a storage-stable liquid washing or cleaning agent containing photocatalytic material and further conventional ingredients of washing or cleaning agents, in which a thickening system as previously described is used.

The present invention also provides a method for applying photocatalytic material to textiles by treating said textiles in a textile treatment bath containing a washing or cleaning agent according to the invention. A modification of this method provides bringing the textile immediately into contact with a washing or cleaning agent according to the invention without requiring a textile treatment bath for this purpose.

The present invention also provides a method for textile cleaning, care, finishing, softening and/or conditioning by treating said textiles in a textile treatment bath containing a washing or cleaning agent according to the invention, accompanied and/or followed by exposure of the textiles to light in the wavelength range from 10-1200 nm. In a modification of this method, textile treatment may also proceed without a textile treatment bath by bringing the textiles to be treated directly into contact with the washing or cleaning agent according to the invention.

If the method according to the invention is directed at the elimination, deactivation or reduction of microorganisms, in particular bacteria and germs, in textiles using light in the wavelength range from 10-1200 nm, a preferred embodiment of the invention is provided.

A method according to the invention for the preventive treatment of textiles in the form of pre-emptive repulsion and inhibition of soiling and stains using light in the wavelength range from 10-1200 nm is in turn a preferred embodiment of the invention.

A method according to the invention for finishing textiles with a photocatalytic material to facilitate the removability of colored dirt (colored stains) from textiles using light in the wavelength range from 10-1200 nm is also a preferred embodiment of the invention.

A method according to the invention for finishing textiles with a photocatalytic material for reducing the fiber adhesion ability of dirt, preferably colored stains, to textiles using light in the wavelength range from 10-1200 nm is likewise a preferred embodiment of the invention.

A method according to the invention for finishing textiles with a photocatalytic material for increasing the water solubility of dirt, preferably colored stains, on textiles using light in the wavelength range from 10-1200 nm is in turn a preferred embodiment of the invention.

A method according to the invention for finishing textiles with a photocatalytic material for preventing the occurrence of fetid odors on the textiles using light in the wavelength range from 10-1200 nm corresponds to a further preferred embodiment of the invention.

A method according to the invention for finishing textiles with a photocatalytic material for providing the textiles with a self-cleaning ability using light in the wavelength range from 10-1200 nm is likewise a preferred embodiment of the invention.

A method according to the invention for the removal or reduction of colored soiling or stains on textiles, which in particular originate from:
red to blue anthocyan dyes, such as for example cyanidine, for example from cherries or blueberries,
red bethanidine from beetroot,
orange-red carotenoids, such as for example lycopene, beta-carotene, for example from tomatoes or carrots,
yellow curcuma dyes, such as for example curcumin, for example from curry and mustard,
brown tannins, for example from tea, fruit, red wine,
deep brown humic acid, for example from coffee, tea, cocoa,
green chlorophyll, for example, from green grass,
industrial dyes from cosmetics, inks, colored pens/pencils,
colored metabolites and/or excretory products of molds or other microflora or microbial growth or microbes,
   using light in the wavelength range from 10-1200 nm,
   is in turn a preferred embodiment of the invention.

A method according to the invention for improving the whiteness of textiles using light in the wavelength range from 10-1200 nm is in turn a preferred embodiment of the invention.

A method according to the invention using an automatic washing machine, preferably an automatic washing machine with a light source, in which the textile treatment agent is in particular added in the postrinsing cycle, is once again a preferred embodiment of the invention.

A method according to the invention, which is a manual method carried out in an open tub, in particular hand washing and/or softening, in which the tub, once the washing liquor has penetrated the textiles, is exposed to light in the wavelength range from 10-1200 nm, in particular sunlight, preferably for a period of >5 minutes, is likewise a preferred embodiment of the invention. All the above-described methods are particularly effective when using light in the visible range (380-800 nm) and/or in the UV range (10-380 nm). In relation to all the above-stated methods, it is in each case a preferred embodiment if light in the wavelength range 380-800 nm and/or in the range 10-380 is used.

The present invention also provides a method for cleaning hard surfaces comprising:
application of a washing or cleaning agent according to the invention onto a hard surface requiring it, accompanied and/or followed by exposure of the surface to light in the wavelength range from 10-1200 nm.

If the hard surfaces are surfaces in interior areas, of wet rooms and/or in exterior areas, preferably
(a) glass articles and products, such as preferably windows, drinking glasses, glass display cabinets,
(b) wood and wood products, such as preferably furniture, wooden floorboards, parquet,
(c) sanitary items, such as preferably sanitary basins and furniture, bathtubs and washbasins, shower curtains, bathroom fittings, tiles,
(d) kitchen fitments and dishes, such as preferably ovens, vitreous ceramic hobs, hotplates, kitchen furniture, kitchen fittings, porcelain articles, ceramic articles, grills (including barbecues)
(e) structures and building materials, such as preferably masonry, papered, enameled, painted walls and/or ceilings, bricks, stonework, render, floor tiles, joints, preferably cement and silicone joints, laminate, plastics surfaces, garage doors, plasterboard,
(f) outdoor fitments and garden accessories, preferably garden furniture, steps, swimming pools, wooden and stone paving, such as for example paving slabs, summerhouses, wooden fencing, ornamental and fruit trees, a preferred embodiment of the invention is provided.

If, after completion of the exposure to light, the hard surface treated with a washing or cleaning agent according to the invention is subjected to mechanical treatment, such as preferably brushing, vacuuming or scrubbing, in particular spraying, preferably by means of a high pressure cleaner, a preferred embodiment of the invention is provided.

If the washing or cleaning agent according to the invention is applied by brushing, rubbing, spraying, wiping or in particular by atomization, preferably by means of high pressure cleaner, a preferred embodiment of the invention is provided.

If the method is directed at the removal of mold and/or mildew spots from hard surfaces such as preferably tile surfaces, cement and silicone joints, papered, enameled, painted walls and/or ceilings, wood, shower curtains, sanitary items, in particular in interior areas, in wet rooms and/or in exterior areas, a preferred embodiment of the invention is provided.

If the method is directed at the removal of algal and/or moss growth, lichens, fungi, in particular molds, bacteria and other microflora and other microbial growth on hard surfaces such as preferably tile surfaces, cement and silicone joints, papered, enameled, painted walls and/or ceilings, wood, shower curtains, sanitary items, in particular in interior areas, in wet rooms and/or in exterior areas, a preferred embodiment of the invention is provided.

If the method is directed at the prevention or inhibition of colonization by algae, moss, lichens, fungi, in particular molds, spores, bacteria and other microflora and other microbial growth on hard surfaces by treating these surfaces with washing or cleaning agents according to the invention accompanied and/or followed by exposure of the substrate to light in the wavelength range from 10-1200 nm, a preferred embodiment of the invention is provided.

All the above-described methods are particularly effective when using light in the visible range (380-800 nm) and/or in the UV range (10-380 nm). In relation to all the above-stated methods, it is in each case a preferred embodiment if a photocatalyst in the wavelength range 380-800 nm and/or in the range 10-380 is used.

The present invention also provides the use of a washing or cleaning agent according to the invention for removing mold and/or mildew spots from hard surfaces such as preferably tile surfaces, cement and silicone joints, papered, enameled, painted walls and/or ceilings, wood, shower curtains, sanitary items using light with a wavelength in the range from 10-1200 nm.

If the use of a washing or cleaning agent according to the invention is directed at the removal or reduction of colored soiling and stains on hard surfaces, which originate from:
red to blue anthocyan dyes, such as for example cyanidine, for example from cherries or blueberries,
red bethanidine from beetroot,
orange-red carotenoids, such as for example lycopene, beta-carotene, for example from tomatoes or carrots,
yellow curcuma dyes, such as for example curcumin, for example from curry and mustard,
brown tannins, for example from tea, fruit, red wine,
deep brown humic acid, for example from coffee, tea, cocoa,
green chlorophyll, for example, from green grass,
industrial dyes from cosmetics, inks, colored pens/pencils,
colored metabolites and/or excretory products of molds or other microflora or microbial growth or microbes,
   using light in the wavelength range from 10-1200 nm,
   a preferred embodiment of the invention is provided.

If the use of a washing or cleaning agent according to the invention is directed at the removal of colored soiling (graffiti) from sprayed items, such as preferably house walls, railway vehicles and transport infrastructure such as underpasses and such as highway bridges using light in the wavelength range from 10-1200 nm, a preferred embodiment of the invention is provided.

If the use of a washing or cleaning agent according to the invention is directed at a preventive treatment of hard surfaces in the form of pre-emptive repulsion and inhibition of soiling and stains, in particular mold and/or mildew spots, using light in the wavelength range from 10-1200 nm, a preferred embodiment of the invention is provided.

If the use of a washing or cleaning agent according to the invention is directed at denaturing or inhibiting the growth of molds, mold spores and lichens or other microflora or other microbial growth or microbes on hard surfaces using light of a wavelength in the range from 10-1200 nm, a preferred embodiment of the invention is provided.

The above-stated uses are particularly effective when using light in the wavelength range 10-380 nm and/or 380-800 nm.

In addition to the essential components thickener and photocatalytic material, the washing or cleaning agents according to the invention may contain still further optional ingredients. The optional components of the washing or cleaning agent according to the invention are in particular described in greater detail below. Unless otherwise stated, weight percentages always relate to the entire washing or cleaning agent.

In addition to the thickening system and the photocatalytic material, the washing or cleaning agents according to the invention preferably contain surfactant(s), it in particular being possible to use anionic, nonionic, cationic and/or amphoteric surfactants. From an applicational standpoint mixtures of anionic and nonionic surfactants are preferred. The total surfactant content of the washing or cleaning agent according to the invention is preferably below 40 wt. % and particularly preferably below 35 wt. %, relative to the total washing or cleaning agent.

If the washing or cleaning agent according to the invention contains nonionic surfactants, a preferred embodiment is provided. Alkoxylated, advantageously ethoxylated, in particular primary alcohols with preferably 8 to 18 C atoms and on average 1 to 12 mol of ethylene oxide (EO) per mol of alcohol, in which the alcohol residue may be linear or preferably methyl-branched in position 2 or may contain linear and methyl-branched residues in the mixture, as are usually present in oxo alcohol residues, are preferably used as nonionic surfactants. In particular, however, alcohol ethoxylates with linear residues prepared from alcohols of natural origin with 12 to 18 C atoms, for example from coconut, palm, tallow fat or oleyl alcohol, and on average 2 to 8 EO per mol of alcohol are preferred. Preferred ethoxylated alcohols include for example C₁₂₋₁₄ alcohols with 3 EO, 4 EO or 7 EO, C₉₋₁₁ alcohol with 7 EO, C₁₃₋₁₅ alcohols with 3 EO, 5 EO, 7 EO or 8 EO, C₁₂₋₁₈ alcohols with 3 EO, 5 EO or 7 EO and mixtures of these, such as mixtures of C₁₂₋₁₄ alcohol with 3 EO and C₁₂₋₁₈ alcohol with 7 EO. The stated degrees of ethoxylation are statistical averages which, for a specific product, may be an integer or a fractional number. Preferred alcohol ethoxylates have a narrow homologue distribution (narrow range ethoxylates, NRE). In addition to these nonionic surfactants, fatty alcohols with more than 12 EO may also be used. Examples of these are tallow fatty alcohol with 14 EO, 25 EO, 30 EO or 40 EO. Nonionic surfactants containing EO and PO groups together in one molecule may also be used according to the invention. In this respect it is possible to use block copolymers with EO-PO block units or PO-EO block units, or also EO-PO-EO copolymers or PO-EO-PO copolymers. It goes without saying that mixed alkoxylated nonionic surfactants may also be used, in which EO and PO units are not distributed in blocks but instead randomly. Such products are obtainable by simultaneous action of ethylene and propylene oxide on fatty alcohols.

Alkyl glycosides of the general formula RO(G)ₓ, in which R means a primary straight-chain or methyl-branched aliphatic residue, in particular methyl-branched in position 2, with 8 to 22, preferably 12 to 18 C atoms and G is the symbol which denotes a glycose unit with 5 or 6 C atoms, preferably glucose, may moreover also be used as further nonionic surfactants. The degree of oligomerization x, which indicates the distribution of monoglycosides and oligoglycosides, is any desired number between 1 and 10; x is preferably 1.2 to 1.4.

A further class of preferably usable nonionic surfactants, which may be used either as sole nonionic surfactant or in combination with other nonionic surfactants, are alkoxylated, preferably ethoxylated or ethoxylated and propoxylated fatty acid alkyl esters, preferably with 1 to 4 carbon atoms in the alkyl chain, in particular fatty acid methyl esters.

Nonionic surfactants of the amine oxide type, for example N-coconut alkyl-N,N-dimethylamine oxide and N-tallow alcohol-N,N-dihydroxyethylamine oxide, and of the fatty acid alkanolamide type may also be suitable. The quantity of these nonionic surfactants preferably amounts to no more than that of the ethoxylated fatty alcohols, in particular no more than half the quantity thereof.

The use of nonionic surfactants gives rise to a particularly good cleaning action and corresponds to a preferred embodiment of the invention.

The content of nonionic surfactants in the washing or cleaning agents according to the invention preferably amounts to 5 to 30 wt. %, preferably 7 to 20 wt. % and in particular 9 to 15 wt. %, in each case relative to the total agent.

Another preferred embodiment is provided if the washing or cleaning agent according to the invention is free of nonionic surfactant, thus contains less than 5 wt. %, 3 wt. %, 2 wt. % or 1 wt. % of nonionic surfactant, in particular none at all, thus contains 0 wt. % of nonionic surfactant.

If the washing or cleaning agent according to the invention contains anionic surfactants, a preferred embodiment is provided. The anionic surfactants used may for example be those of the sulfonate and sulfate type. Surfactants of the sulfonate type which may here preferably be considered are C₉₋₁₃ alkylbenzene sulfonates, olefin sulfonates, i.e. mixtures of alkene and hydroxyalkane sulfonates and disulfonates, as are obtained, for example, from C₁₂₋₁₈ monoolefins with a terminal or internal double bond by sulfonation with gaseous sulfur trioxide and subsequent alkaline or acidic hydrolysis of the sulfonation products. Alkane sulfonates which are obtained from C₁₂₋₁₈ alkanes for example by sulfochlorination or sulfoxidation with subsequent hydrolysis or neutralization are also suitable. Likewise, the esters of α-sulfofatty acids (ester sulfonates) are also suitable, for example the α-sulfonated methyl esters of hydrogenated coconut, palm kernel or tallow fatty acids.

Further suitable anionic surfactants are sulfated fatty acid glycerol esters. Fatty acid glycerol esters are understood to mean mono-, di- and triesters and mixtures thereof, as are obtained during production by esterification of a monoglycerol with 1 to 3 mol of fatty acid or on transesterification of triglycerides with 0.3 to 2 mol of glycerol. Preferred sulfated fatty acid glycerol esters are here the sulfated products of saturated fatty acids with 6 to 22 carbon atoms, for example caproic acid, caprylic acid, capric acid, myristic acid, lauric acid, palmitic acid, stearic acid or behenic acid.

Preferred alk(en)yl sulfates are the alkali metal and in particular sodium salts of sulfuric acid semi-esters of C₁₂-C₁₈ fatty alcohols for example prepared from coconut fatty alcohol, tallow fatty alcohol, lauryl, myristyl, cetyl or stearyl alcohol or C₁₀-C₂₀ oxo alcohols and those semi-esters of secondary alcohols of these chain lengths. Alk(en)yl sulfates of the stated chain length which contain a synthetic straight-chain alkyl residue produced on a petrochemical basis and which exhibit degradation behavior similar to that of the appropriate compounds based on fatty chemical raw materials are also preferred. C₁₂-C₁₆ alkyl sulfates and C₁₂-C₁₅ alkyl sulfates and C₁₄-C₁₅ alkyl sulfates are preferred because of their washing characteristics. 2,3-Alkyl sulfates, which may for example be obtained as commercial products from Shell Oil Company under the name DAN®, are suitable anionic surfactants.

The sulfuric acid monoesters of straight-chain or branched C₇₋₂₁ alcohols ethoxylated with 1 to 6 mol of ethylene oxide are also suitable, such as 2-methyl-branched C₉₋₁₁ alcohols with on average 3.5 mol of ethylene oxide (EO) or C₁₂₋₁₈ fatty alcohols with 1 to 4 EO. Due to their strong foaming behavior, they are used in cleaning agents in only relatively small quantities, for example in quantities of 1 to 5 wt. %.

Further suitable anionic surfactants are the salts of alkylsulfosuccinic acid, which are also known as sulfosuccinates or sulfosuccinic acid esters, and are the monoesters and/or diesters of sulfosuccinic acid with alcohols, preferably fatty alcohols and in particular ethoxylated fatty alcohols. Preferred sulfosuccinates contain C₈₋₁₈ fatty alcohol residues or mixtures thereof. Particularly preferred sulfosuccinates contain a fatty alcohol residue which is derived from ethoxylated fatty alcohols, which are in themselves nonionic surfactants (see description below). Sulfosuccinates whose fatty alcohol residues are derived from ethoxylated fatty alcohols with a narrow homolog distribution are here particularly preferred. It is likewise also possible to use alk(en)ylsuccinic acid with preferably 8 to 18 carbon atoms in the alk(en)yl chain or the salts thereof.

Particularly preferred anionic surfactants are soaps. Saturated and unsaturated fatty acid soaps are in particular suitable, such as the salts of lauric acid, myristic acid, palmitic acid, stearic acid, (hydrogenated) erucic acid and behenic acid and in particular soap mixtures derived from natural fatty acids, for example coconut, palm kernel, olive oil or tallow fatty acids.

The anionic surfactants, including the soaps, may be present in the form of the sodium, potassium or ammonium salts thereof and as soluble salts of organic bases, such as mono-, di- or triethanolamine. The anionic surfactants are preferably present in the form of the sodium or potassium salts thereof, in particular in the form of the sodium salts.

The content of anionic surfactants in preferred liquid washing or cleaning agents amounts to 2 to 30 wt. %, preferably to 4 to 25 wt. % and in particular to 5 to 22 wt. %, in each case relative to the total agent. It is particularly preferred for the quantity of fatty acid soap to amount to at least 2 wt. % and particularly preferably at least 3 wt. % and particularly preferably at least 4 wt. %.

Another preferred embodiment is provided if the washing or cleaning agent according to the invention is free of anionic surfactant, thus contains less than 5 wt. %, 3 wt. %, 2 wt. % or 1 wt. % of anionic surfactant, in particular none at all, thus contains 0 wt. % of anionic surfactant.

The viscosity of the washing or cleaning agents according to the invention may be measured with conventional standard methods (for example Brookfield viscosimeter LVT-II at 20 rpm and 20° C., spindle 3) and is preferably in the range from 1500 to 5000 mPa·s. Preferred agents have viscosities of 2000 to 4000 mPa·s, with values of around 3500 mPa·s being particularly preferred.

The washing or cleaning agents according to the invention may contain further optional ingredients which further enhance the applicational and/or aesthetic properties of the washing or cleaning agent according to the invention, for example from the group of builders, bleaching agents, bleaching activators, enzymes, electrolytes, nonaqueous solvents, pH adjusting agents, fragrances, perfume carriers, fluorescent agents, dyes, hydrotropes, foam inhibitors, silicone oils, antiredeposition agents, optical brighteners, graying inhibitors, shrinkage prevention agents, anticrease agents, dye transfer inhibitors, antimicrobial active substances, germicides, fungicides, antioxidants, corrosion inhibitors, antistatic agents, ironing aids, waterproofing and impregnation agents, antiswelling and antislip agents and UV absorbers.

If the washing or cleaning agent according to the invention contains builders, a preferred embodiment is provided. Possible builders, which may be present in the washing or cleaning agents according to the invention, are in particular silicates, aluminum silicates (in particular zeolites), carbonates, salts of organic di- and polycarboxylic acids and mixtures of these substances.

Suitable crystalline, layered sodium silicates have the general formula NaMSiₓO₂ₓ₊₁.H₂O, M meaning sodium or hydrogen, x being a number from 1.9 to 4 and y a number from 0 to 20 and preferred values for x being 2, 3 or 4. Preferred crystalline phyllosilicates of the stated formula are those in which M denotes sodium and x assumes the values 2 or 3. In particular, both β- and δ-sodium disilicates Na₂Si₂O₅.yH₂O are preferred. In a preferred embodiment of the invention, the washing or cleaning agent according to the invention may however, for example, also contain only small quantities of crystalline, layered sodium silicates, in particular none at all, thus 0 wt. %.

Generally known phosphates may, of course, also be used as builder substances, provided that such use should not be avoided on environmental grounds. The sodium salts of orthophosphates, pyrophosphates and in particular of tripolyphosphates are particularly suitable.

Enzymes which may in particular be considered are those from the classes of hydrolases such as proteases, esterases, lipases or lipolytically active enzymes, amylases, cellulases or other glycosylhydrolases and mixtures of the stated enzymes. In laundry, all these hydrolases contribute to the removal of stains such as those containing protein, fat or starch and of graying. By removing pilling and microfibrils, cellulases and other glycosylhydrolases may furthermore contribute to color retention and to increasing textile softness. Oxyreductases may also be used for bleaching or for inhibiting color transfer. Enzymatic active substances isolated from strains of bacteria or fungi such as Bacillus subtilis, Bacillus licheniformis, Streptomyces griseus and Humicola insolens are particularly suitable. Proteases of the subtilisin type and in particular proteases isolated from Bacillus lentus are preferably used. Enzyme mixtures, for example of protease and amylase or protease and lipase or lipolytically active enzymes or protease and cellulase or of cellulase and lipase or lipolytically active enzymes or of protease, amylase and lipase or lipolytically active enzymes or protease, lipase or lipolytically active enzymes and cellulase, but in particular mixtures containing protease and/or lipase or mixtures with lipolytically active enzymes are of particular interest for this purpose. Examples of such lipolytically active enzymes are the known cutinases. Peroxidases or oxidases have also proved suitable in some cases. Suitable amylases include in particular α-amylases, iso-amylases, pullulanases and pectinases. Cellobiohydrolases, endoglucanases and β-glucosidases, which are also known as cellobiases, or mixtures of these are preferably used as cellulases. Since different types of cellulase may differ in terms of their CMCase and avicelase activities, desired activities may be established by targeted mixing of the cellulases. It is particularly advantageous for the washing or cleaning agents according to the invention to contain mannanase, specifically in particular incorporated in microcapsules and/or speckles. This corresponds to a preferred embodiment of the invention. It has been found that mannanase in conjunction with the photocatalytic material provided particularly good performance in detaching soil in residues containing galactomannan residues on textiles and hard surfaces. The use of tannase is also preferred.

The enzymes may be adsorbed on support materials in order to protect them from premature decomposition. The proportion of enzymes, liquid enzyme formulations or enzyme mixtures may for example amount to approx 0.1 to 5 wt. %, preferably to 0.12 to approx 2.5 wt. %. In a preferred embodiment of the invention, the washing or cleaning agent according to the invention may however, for example, also contain only small quantities of enzymes, in particular none at all, thus 0 wt. %.

Optional nonaqueous solvents which may be used in the washing or cleaning agents according to the invention originate for example from the group of mono- or polyhydric alcohols, alkanolamines or glycol ethers. The solvents are preferably selected from ethanol, n- or i-propanol, butanols, glycol, butanediol, glycerol, diglycol, diethylene glycol monobutyl ether, hexylene glycol, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl, ethyl or propyl ether, dipropylene glycol monomethyl or monoethyl ether, diisopropylene glycol monomethyl or monoethyl ether, methoxy, ethoxy or butoxytriglycol, 1-butoxyethoxy-2-propanol, 3-methyl-3-methoxybutanol, propylene glycol t-butyl ether and mixtures of these solvents. These optional nonaqueous solvents may be used in washing or cleaning agents according to the invention in quantities of between 0.5 and 8 wt. %, but preferably of below 5 wt. % and in particular of below 3 wt. %.

To bring the pH value of the washing or cleaning agents according to the invention into the desired range, the use of pH adjusting agents may be indicated. In this case, any known acids or alkalies may be used, provided that their use is not prohibited for applicational or environmental reasons or for reasons of consumer protection. Conventionally, the quantity of these adjusting agents does not exceed 10 wt. % of the total formulation.

To prevent decomposition catalyzed by heavy metals of certain washing agent ingredients, substances may be used which complex heavy metals. Suitable heavy metal complexing agents are for example the alkali metal salts of ethylenediaminetetraacetic acid (EDTA) or nitrilotriacetic acid (NTA) and alkali metal salts of anionic polyelectrolytes such as polymaleates and polysulfonates.

A preferred class of complexing agents comprises phosphonates, which are contained in preferred washing or cleaning agents according to the invention in quantities of from 0.01 to 2.5 wt. %, preferably of 0.02 to 2 wt. % and in particular of 0.03 to 1.5 wt. %. These preferred compounds in particular include organophosphonates such as for example 1-hydroxyethane-1,1-diphosphonic acid (HEDP), aminotri(methylenephosphonic acid) (ATMP), diethylenetriaminepenta(methylenephosphonic acid) (DTPMP or DETPMP) and 2-phosphonobutane-1,2,4-tricarboxylic acid (PBS-AM), which are mainly used in the form of the ammonium or alkali metal salts thereof.

The resultant washing or cleaning agents according to the invention are preferably clear, i.e. they comprise no sediment and are preferably transparent or at least translucent. Without addition of a dye, the washing or cleaning agents according to the invention preferably exhibit visible light transmission (410 to 800 nm) of at least 30%, preferably of at least 50% and particularly preferably of at least 75%.

In a preferred embodiment, the washing or cleaning agent optionally contains one or more perfumes (perfume oils, odoriferous substances) for example in a quantity of conventionally up to 10 wt. %, preferably of 0.01 to 5 wt. %, in particular of 0.05 to 3 wt. %, particularly preferably of 0.1 to 2 wt. % and extremely preferably of 0.4 to 0.8 wt. %. The quantity of perfume used is here also dependent of the type of application.

Perfume oils (odoriferous substances, fragrances) which may be used are individual odoriferous compounds, for example synthetic products of the ester, ether, aldehyde, ketone, alcohol and hydrocarbon type. Preferably, however, mixtures of various odoriferous substances are used which together produce an attractive fragrance note. Such perfume oils may also contain natural odoriferous substance mixtures, as are obtainable from plant sources.

The term perfume oil is intended to mean self-contained fragrance compositions which are commonly used for product fragrancing and in particular are considered to smell pleasant by humans. This will be illustrated by an example. If a person skilled in the art wishes to make, for example, a cleaning agent fragrant, he/she usually adds thereto not just one substance which has a (pleasant) smell, but instead a group of substances which have a (pleasant) smell. Such a group usually consists of a plurality of individual odoriferous substances, for example more than 10 or 15, preferably up to 100 or more. These odoriferous substances combine to form a desired pleasant smelling and harmonious odor picture.

A usable perfume oil may contain individual odoriferous compounds, for example synthetic products of the ester, ether, aldehyde, ketone, alcohol and hydrocarbon type. Odoriferous compounds of the ester type are for example benzyl acetate, phenoxyethyl isobutyrate, p-tert.-butylcyclohexyl acetate, linalyl acetate, dimethylbenzylcarbinyl acetate (DMBCA), phenylethyl acetate, benzyl acetate, ethylmethylphenyl glycinate, allylcyclohexyl propionate, styrallyl propionate, benzyl salicylate, cyclohexyl salicylate, floramate, melusate and jasmecyclate. Ethers include, for example, benzyl ethyl ether and ambroxan, aldehydes include, for example, linear alkanals with 8-18 C atoms, citral, citronellal, citronellyloxyacetaldehyde, cyclamen aldehyde, lilial and bourgeonal, ketones include, for example, ionones, α-isomethylionone and methyl cedryl ketone, alcohols include anethole, citronellol, eugenol, geraniol, linalool, phenylethyl alcohol and terpineol, hydrocarbons mainly include terpenes such as limonene and pinene. Preferably, however, mixtures of various odoriferous substances are used which together produce an attractive fragrance note of the resultant perfume oil.

The perfume oils may, however, also contain natural odoriferous substance mixtures, as are obtainable from plant sources, for example pine, citrus, jasmine, patchouli, rose or ylang-ylang oil. Likewise suitable are muscatel sage oil, chamomile oil, clove oil, melissa oil, mint oil, cinnamon leaf oil, lime blossom oil, juniper berry oil, vetiver oil, olibanum oil, galbanum oil and labdanum oil and orange-blossom oil, neroli oil, orange peel oil and sandalwood oil.

If it is to be perceptible, an odoriferous substance must be volatile, wherein, in addition to the nature of the functional groups and the structure of the chemical compound, an important role is also played by molar mass. Most odoriferous substances accordingly have molar masses of up to approx. 200 Dalton, while molar masses of 300 Dalton and above tend to be the exception. Due to the differing volatility of odoriferous substances, the odor of a perfume composed of two or more odoriferous substances varies over the course of vaporization, it being possible to subdivide odor impressions into “head or top note”, “heart or middle note” and “end note or dry-out”.

In a preferred embodiment, the washing or cleaning agent according to the invention contains specific minimum values of perfume oil (odoriferous substances), namely at least 0.00001 wt. %, advantageously at least 0.0001 wt. %, considerably advantageously at least 0.001 wt. %, more advantageously at least 0.01 wt. %, even more advantageously at least 0.1 wt. %, still more advantageously at least 0.2 wt. %, very advantageously at least 0.3 wt. %, particularly advantageously at least 0.4 wt. %, very particularly advantageously at least 0.45 wt. %, considerably advantageously at least 0.5 wt. %, very considerably advantageously at least 0.55 wt. %, extremely advantageously at least 0.6 wt. %, extremely advantageously at least 0.65 wt. %, extremely advantageously at least 0.7 wt. %, exceptionally advantageously at least 0.75 wt. %, extraordinarily advantageously at least 0.8 wt. %, extraordinarily advantageously at least 0.85 wt. %, in particular at least 0.9 wt. % of perfume oil, relative to the total washing or cleaning agent.

According to a further specific embodiment, the washing or cleaning agent according to the invention may be entirely free of perfume oil (odoriferous substances). It is, however, distinctly more preferred for odoriferous substances to be present.

The washing or cleaning agents according to the invention may be produced by preferably providing the liquid washing or cleaning agent per se by conventional methods and then adding the material to be dispersed (photocatalytic material, speckles, microcapsules) and homogeneously dispersing it in the washing or cleaning agent according to the invention by mixing.

What is claimed is:

1. A liquid washing or cleaning agent, comprising a photocatalytic material and a thickening system.

2. The agent of claim 1, wherein the thickening system comprises:
a) a polyacrylate or derivative thereof;
b) a structure-imparting gum;
c) a cellulose ether derivative;
d) a clay mineral; or
e) any mixture of a) to d).

3. The agent of claim 2, wherein the thickening system comprises a combination of a polyacrylate or derivative thereof and a structure-imparting gum or a cellulose ether derivative.

4. The agent of claim 1, wherein the photocatalytic material comprises titanium dioxide.

5. The agent of claim 4, wherein the titanium dioxide comprises a carbon-modified titanium dioxide.

6. A method for applying photocatalytic material to textiles, comprising the steps of forming a textile treatment bath comprising the washing or cleaning agent of claim 1 and contacting a textile with the textile treatment bath.

7. A method for textile cleaning, care, finishing, softening, or conditioning, comprising contacting a textile with a textile treatment bath comprising the washing or cleaning agent of claim 1 and exposing the textile to light in the wavelength range from 10-1200 nm.

8. The method of claim 7, further comprising the elimination, deactivation or reduction of microorganisms in the textile using light in the wavelength range from 10-1200 nm.

9. The method of claim 7, further comprising pre-emptive repulsion and inhibition of soiling and stains using light in the wavelength range from 10-1200 nm.

10. The method of claim 7, wherein the photocatalytic material facilitates the removability of colored stains from the textile using light in the wavelength range from 10-1200 nm.

11. The method of claim 7, wherein the photocatalytic material reduces fiber adhesion ability of dirt to the textile using light in the wavelength range from 10-1200 nm.

12. The method of claim 7, wherein the photocatalytic material increases water solubility of dirt on the textile using light in the wavelength range from 10-1200 nm.

13. The method of claim 7, wherein the photocatalytic material prevents the occurrence of fetid odors on the textile using light in the wavelength range from 10-1200 nm.

14. The method of claim 7, wherein the photocatalytic material provides the textile with a self-cleaning ability using light in the wavelength range from 10-1200 nm.

15. The method of claim 7, wherein the photocatalytic material improves the whiteness of the textile using light in the wavelength range from 10-1200 nm.

16. The method of claim 7, further comprising using an automatic washing machine, in which the washing or cleaning agent is added in the postrinsing cycle.
